(19) United States
(12) Patent Application Publication
(10) Pub. No.: US 2012/0255505 A1
(43) Pub. Date: Oct. 11, 2012

(54) Tetherless animal leash using bluetooth wireless technology

(76) Inventor: Jacob Turner Gauthier, Sebastopol, CA (US)

(21) Appl. No.: 13/066,168

(22) Filed: Apr. 8, 2011

(51) Int. Cl. A01K 15/04; A01K 29/00

(52) U.S. Cl. 119/721

(57) ABSTRACT

One embodiment of an animal-bound device using a Bluetooth module (14) and technology to limit or control animal movement in relation to a user's Bluetooth-enabled device. Device has user input and visual response (16-20) Animal is controlled by deterrent (15) on programming on on-board storage and microprocessor (13).

### CROSS-REFERENCE TO RELATED APPLICATIONS

This application claims the benefit of provisional patent application Ser. No. 61/211,617 filed Mar. 31, 2009 by the present inventor.

### FEDERALLY SPONSORED RESEARCH

Not Applicable

### SEQUENCE LISTING OR PROGRAM

Not Applicable

### FIELD

This application relates to electronic animal control and training devices, specifically to such devices emitting signals for behavioral modification using advanced wireless technologies.

### PRIOR ART

Traditionally animals are controlled with a leash or tether limiting range of movement. This can cause physical discomfort for the animal or the user during normal use and can become tangled around either party. While animal harnesses and retractable leashes minimize some risk large animals can still pull around an owner. This is especially true for very young, old, or physically disabled owners.

Thereafter several methods or electronic animal fences have been developed by several companies. These use a special collar or device which reacts to an electromagnetic or other current running along a wire in the ground. These containment solutions are costly to set up, lack portability, and are difficult to deploy without thorough understanding of the technology.

Electronic devices for animal training have been produced by many companies. The user will usually input commands into a large radio device which sends a response to the dog. This is used for behavioral training and such systems are not used to contain or control an animal's range of movement.

None of these devices use Bluetooth wireless technology and computations of the signal strength thereof to limit and control an animal's range of movement. Electric fences are the only animal control solution that behaves passively without requiring constant user attention and input. Furthermore, very few animal devices are capable of using Bluetooth wireless technology and connecting to user Bluetooth capable devices. While some existing patents use Bluetooth to transmit health information, none require the user's device of choice for the primary functions of measuring and limiting distance.

### SUMMARY

In accordance with one embodiment a device comprises using Bluetooth wireless technology limiting an animal's range of movement in relation to another Bluetooth device.

### DRAWINGS

### Figures

In the drawings, alternate views of figures have the same number but different alphabetic suffixes.

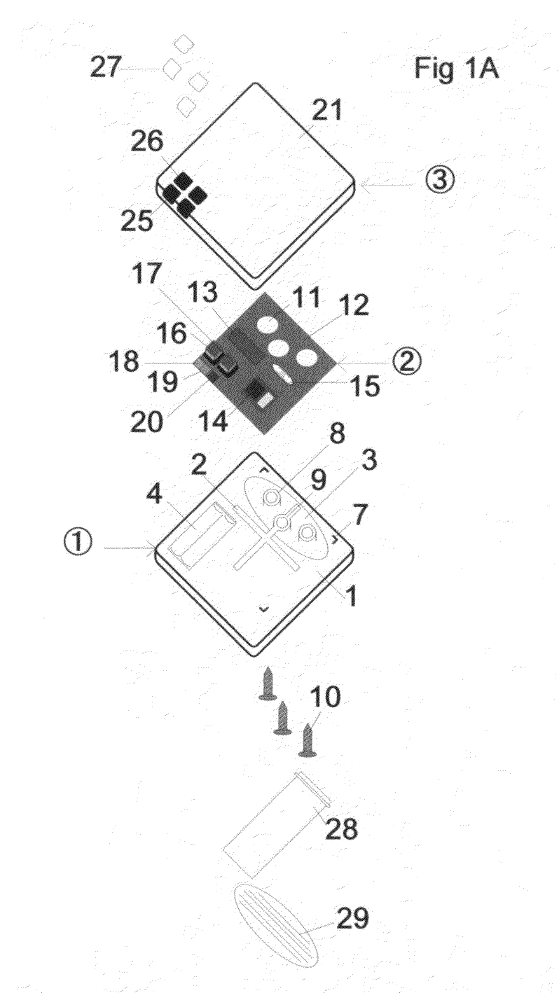

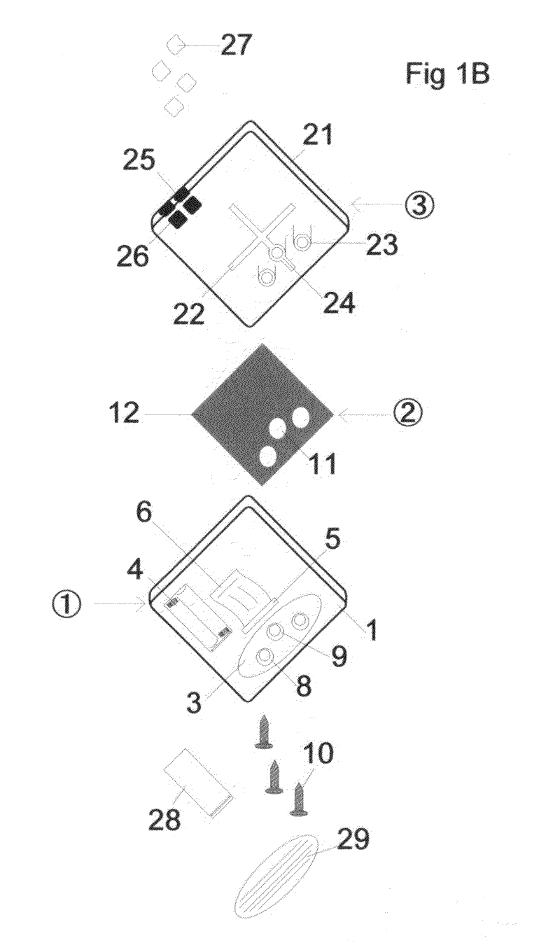

FIGS. 1A and 1B show an exploded view of a device.

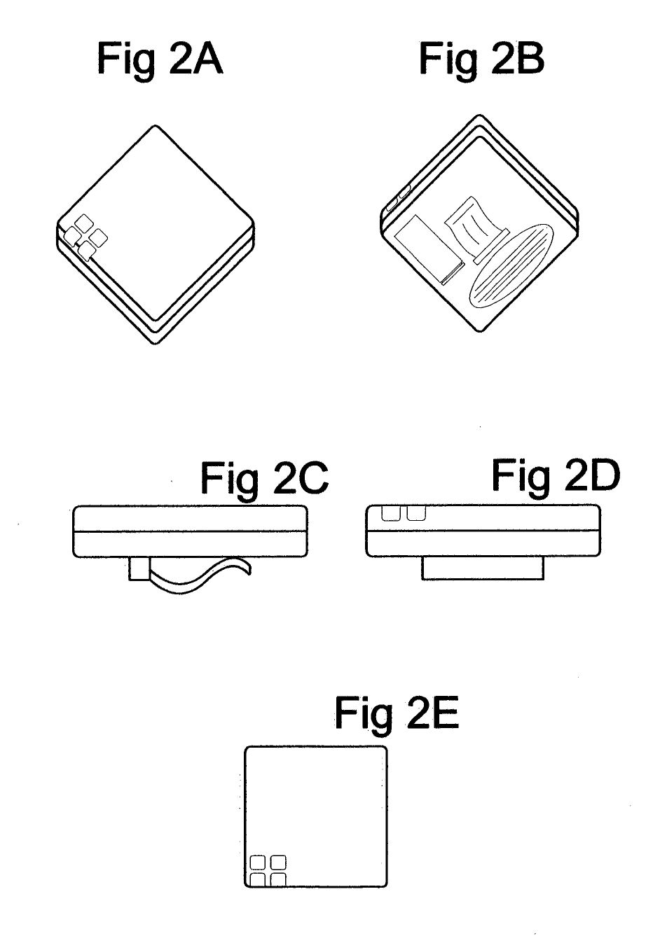

FIGS. 2A to 2E show various views of a fully assembled device.

FIG. 3 shows a device with the battery cover and back label removed.

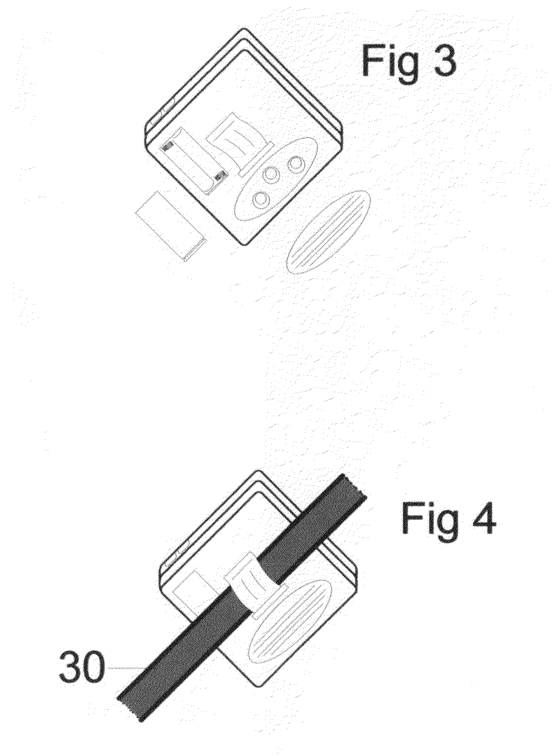

FIG. 4 shows a view of the device applied to a segment of an animal collar.

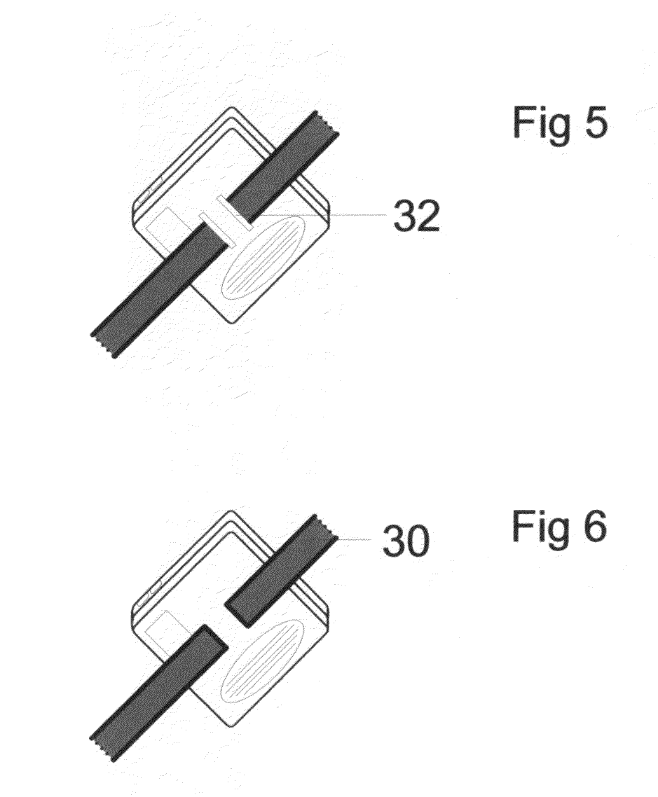

FIG. 5 shows a segment of an animal collar inserted through a slot.

FIG. 6 shows a segment of an animal collar attached to the device.

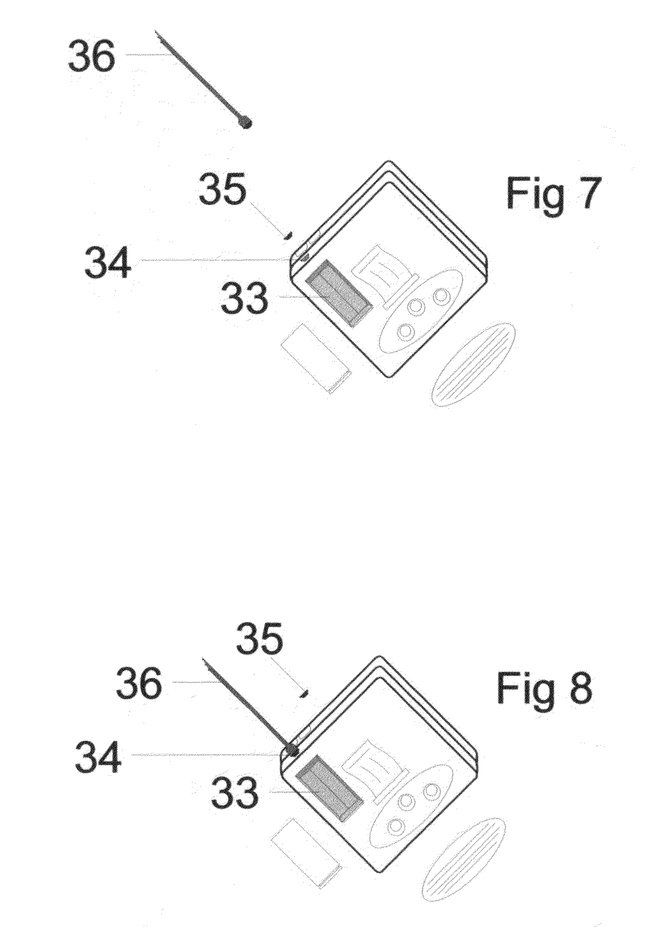

FIG. 7 shows a rechargeable device's battery and a charging cable segment.

FIG. 8 shows a device charging.

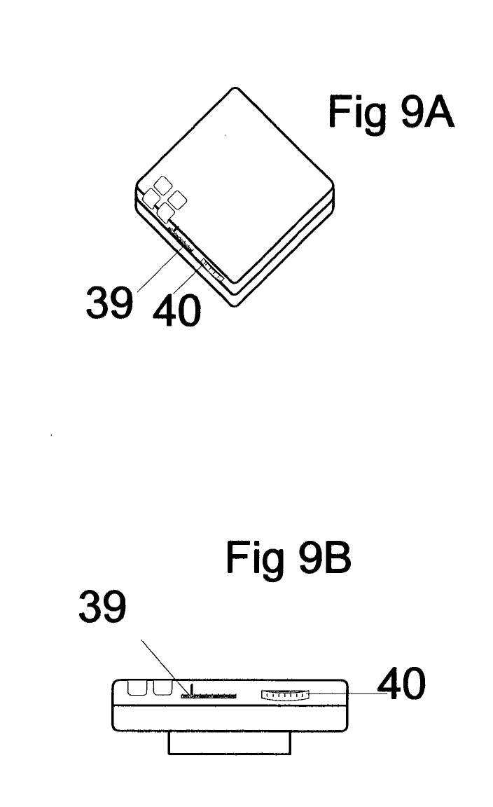

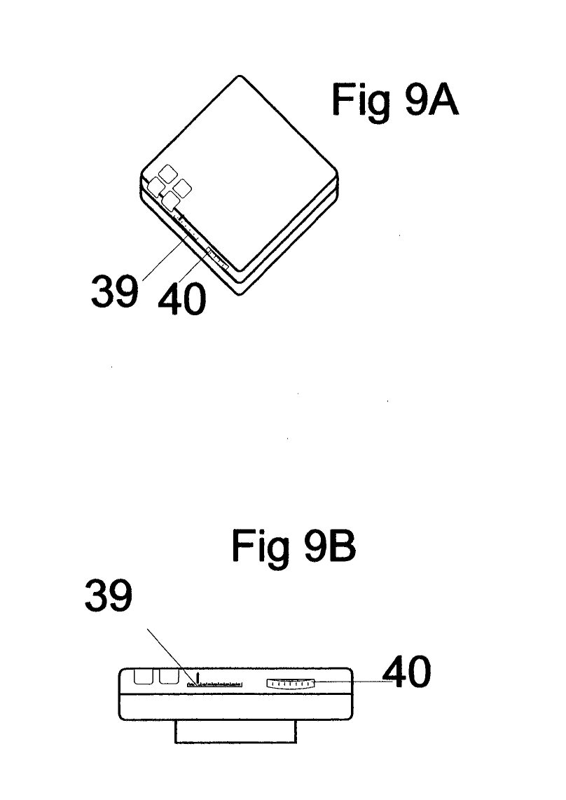

FIGS. 9A and 9B show an embodiment with adjustable range and more inputs.

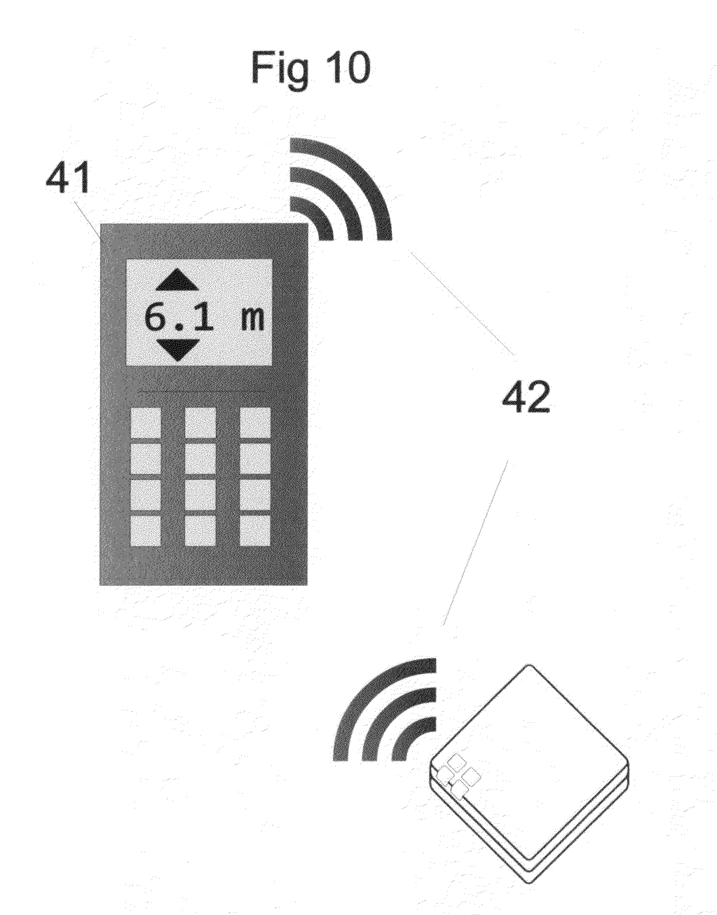

FIG. 10 shows a device connecting to and sharing data with a Bluetooth enabled cellular phone.

FIG. 11 shows an embodiment with multiple Bluetooth modules

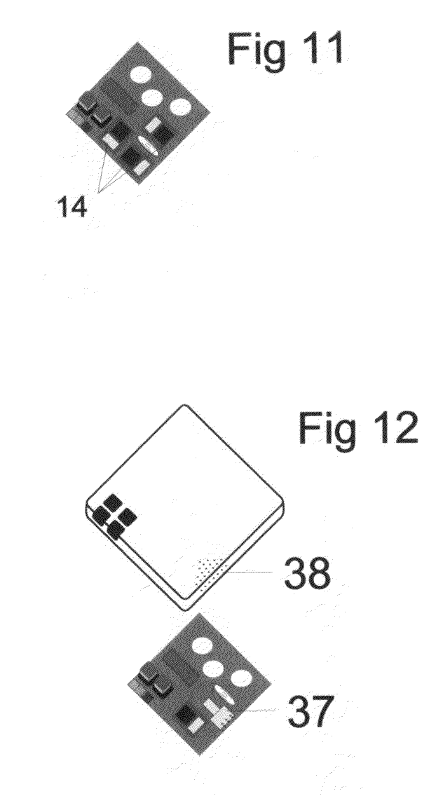

FIG. 12 shows an embodiment with a microphone and modified top case.

### Reference Numerals

\textcircled{1} Bottom piece

\textcircled{2} Main circuit

\textcircled{3} Top piece

1 Bottom plastic casing

2 Cross for reinforcement—bottom

3 Intented (external) oval for label

4 Battery enclosure

5 Protruding plastic spine for clip

6 Clip

7 Embossed (internal) corners to hold circuit

8 Screw hole—bottom (2×)

9 Screw hole intersected by cross for reinforcement—bottom

10 Screws (3×)

11 Screw holes—PCB (3×)

12 PCB—Circuit board

13 Microcontroller

14 Bluetooth Module

15 Speaker

16 Power button

17 Bluetooth button

18 Power LED—green

19 Power LED—red

20 Blutooth LED—blue

21 Top plastic casing

22 Cross for reinforcement—top

23 Screw hole—top (2×)

24 Screw hole intersected by cross for reinforcement—top

25 Holes for LEDs (2×)

26 Holes for buttons (2×)

27 Clear plastic caps (4×)

28 Battery cover

29 Back label

30 Animal collar (not included)

31 Batteries (not included)

32 Empty slot

33 Lithium-ion Battery

34 Mini-USB Port

35 Cap for Mini-USB Port

36 Mini-USB Cable

37 Microphone

38 Audio Holes

39 Adjustable Switch

40 Adjustable Dial

41 Bluetooth-Enabled Device

42 Wireless Transmission

### DETAILED DESCRIPTION

### First Embodiment—FIGS. 1-4

The preferred embodiment the device is illustrated in FIGS. 1-4. The device is composed of three main pieces: the bottom plastic piece \textcircled{1}, the main circuit \textcircled{2}, and the top plastic piece \textcircled{3}. The two plastic pieces and the battery cover 28 are the only three solid plastic parts of the device. The face with the clip 6 is the bottom of the device and the opposite flat face of the top plastic casing 21 is the top of the device. The three main pieces are held together with three screws 10 at screw holes 8 and 9. In assembly the screw heads enter the bottom screw holes 8 and hold the PCB board 12 to the top screw holes 11.

The bottom plastic case 1 is supported by: an extruding plastic cross 2 on the inside, screw holes 8 and 9, and the battery casing 4. The bottom plastic case 1 is indented from the outside in an oval shape 3. The clip is attached to the bottom plastic case 1 by an extruding plastic spine 5.

The two plastic casings \textcircled{1} and \textcircled{3} house and protect the main circuit \textcircled{2}. The main circuit \textcircled{2} is on PCB board 12 and has three screw holes. The support of three screws 10 keeps the circuit from moving or becoming damaged during heavy use. In this embodiment the PCB board 12 is mounted with: a microcontroller 13 to act as a CPU receiving and outputting information and controls, a small speaker and/or motor 15, a Bluetooth module 14 which communicates with other Bluetooth devices (not shown) and the microcontroller 13, two buttons 16 and 17 which act as input to the microcontroller 13, and three bright display LEDs of the colors green 18, red 19, and blue 20.

The top plastic casing 21 is supported by an extruding plastic cross 22 on the inside and screw holes 23 and 24. In this embodiment the top surface has four holes, two of which are for buttons 16 and 17 and two more of which are for light from LEDs 18-20. Four clear plastic caps 27 are placed, snapped or glued into place. These retain the functionality of the buttons 16 and 17, retain the visibility of the LED lights 18-20, keep dirt and foreign material (not shown) out of the device, and add to aesthetics.

The battery cover 28 is the same size as the depressed battery enclosure 4 and the two are designed to fit flush together as not to extrude from the device.

The back label 29 can display device information, symbols, icons, company information, legal information, or any other text or graphics which may or may not be included with the device's packaging (not shown).

The dimensions of this embodiment are 3 cm×3 cm×1 cm. The edges are rounded as to improve comfort and prevent physical injury. This embodiment is held together primarily by three screws 10. These screws enter the bottom plastic casing 1 through its screw holes 8 and 9. The screws go through the PCB screw holes 11 on the circuit board 12 and up further through screw holes 23 and 24 on the inside of the top plastic casing 21. The main circuit \textcircled{2} is held in place by these screws and small supports 7 on the bottom plastic casing 1. All plastic screw holes 8 9 23 and 24 are extruding and the hole at top is narrow. This is to better support the main circuit \textcircled{2} and adhere to the screws 10 well.

### Operation—FIGS. 2, 3, 4

Before operation, one should ensure that their Bluetooth compatible device (not shown) is powered on and has a reasonable remaining electric power. When this embodiment is removed from its packaging (not shown) one inserts batteries (not shown) into the battery casing 4. The battery cover 28 is then applied. The device attaches to an animal collar 30 (not included with the device) with the clip 6.

Once the above preparations are complete, the user presses the power button 16 to power on the device. When the power is on the green LED 18 will light. If the remaining battery power is low the red LED 19 will light instead. This embodiment will automatically enter “discoverable” mode, in which it will transmit wireless data that allow the device to connect with another Bluetooth device. While this embodiment is in “discoverable” mode the blue LED 20 will blink. The user must then use their Bluetooth compatible wireless device to connect with this embodiment. This may be as little as one button press, but exact operation of the users Bluetooth compatible wireless device can vary and will not be included in this description of operation. Users should contact their device's manufacturer should they have problems using or learning their Bluetooth compatible wireless device's operation. (e.g. Apple for iPhone users)

After the user's Bluetooth compatible wireless device is connected or “paired” with this embodiment, setup is complete. While this embodiment is connected the blue LED 20 will light. While the two devices are close to each other, nothing will happen and they will remain paired. The compatible wireless device should remain with the user, and the animal collar 30 should be on the animal. If the animal begins to move away from the user and the strength of the wireless signal decreases, this embodiment will emit a deterrent signal in the form of an ultrasonic tone, vibration, or sound clip from the speaker 15. Combinations of these deterrents may be used as well. The ultrasonic tone is of a high pitch which humans can't hear. If the animal has just begun to go out of range then the tone is of a low volume. As the animal goes further and the signal strength becomes increasingly weak, the volume increases. In this way the animal experiences a sound that ranges from slightly annoying to extremely unpleasant proportionally as the distance between them and the user increases.

If the user presses the Bluetooth button 17 this embodiment will wirelessly disconnect from any devices and will then enter “discoverable” mode as if it had just been powered on. This function is for users who want to reconnect or connect this embodiment with a different Bluetooth compatible wireless device.

When the user is done using this embodiment they press the power button 16 to power off this embodiment. It may then be removed from the animal collar 30 if the user chooses.

### FIGS. 5-10—Alternative Embodiments

There are various ways to affix the device to a dog collar without use of a clip. FIG. 5 illustrates a device with a slot to feed a collar through. FIG. 6 illustrates a device with a segment of permanently attached collar or harness. Interior rechargeable batteries as shown in FIG. 7 may be preferable to disposable batteries. FIG. 8 shows a cable attached to the device to serve as a traditional leash or as a power transfer cable.

FIG. 9 shows a device with inputs for the user to define effective range. FIG. 10 shows a version receiving data from the user's Bluetooth capable device to define effective range. It may be possible to grain enhanced measurement precision by using multiple Bluetooth modules in the circuitry as shown by FIG. 11. FIG. 12 shows a device with a built-in microphone for audio recording and playback.

### Advantages

From the description above, a number of advantages of some embodiments of my tetherless animal control device become evident:

(a) The hands-free use allows the user to safely focus on their animal and surroundings.

(b) Without a taught leash the animal's neck and user's hands will be more comfortable.

(c) Young and elderly users will not be pulled about by large dogs using this device.

(d) The device's Bluetooth wireless technology can be used with other animal training devices without interference.

(e) The device works with any other Bluetooth capable device—an open wireless technology more than a decade old supported by millions of devices.

(f) Different types of humane animal discouragement give customizability or maximum effectiveness such as vibration, hyper-frequency audio, audible frequency audio, spray, and shock.

### Conclusion, Ramifications, and Scope

The device is not meant to act as a complete substitute for an animal leash. Leash laws do not extend to electronic devices and the device is intended for use on private property when one does not want their animal on a leash but still wants them close by. In certain embodiments percentage will be more reliable and safe than a measured distance depending on the user's Bluetooth compatible device.

Although the description above contains many specificities, these should not be construed as limiting the scope of embodiments but mearly providing illustrations of some of the presently preferred embodiments. For example, a Bluetooth adaptor or modem may be included in the same electronic component as the microcontroller; an extra or external antennae may improve results; variants with open-source programming and design are possible; the device could serve a dual-function as another existing type of animal training device; a Bluetooth PIN code may be used during pairing for additional security; the casing may be made of other materials than plastic, one cell phone may be able to connect to multiple devices, the device may be adapted for use with children, dolphins, etc.

Thus scope of the embodiments should be determined by the appended claims and their legal equivalents, rather than by the examples given.

I claim:

1. a small electronic device comprising:
a) case housing the circuitry
b) means on said case to bound said device to a user's animal
c) an electronic Bluetooth module on said circuitry
d) means of connection from said Bluetooth module to a user's Bluetooth-capable device enabling detection of signal strength
e) means for giving said animal a response from said circuitry
whereby said small electronic device will limit the animals range of movement by delivering said response to said animal based on said signal strength.

2. A method for controlling a user's animal's range of movement using Bluetooth wireless technology, comprising the steps of:
a) providing said small device on said animal, and
b) connecting said small device to said user's Bluetooth-capable device, and
c) measuring said signal strength between itself and said user's Bluetooth-capable device, and
d) calculating response to said animal using said signal strength, and
e) delivering said response
whereby said small device may deliver said response to said animal based on the animal's distance from said user's Bluetooth-capable device

3. A method for controlling an animal comprising the following steps;
a) affixing small device to an animal, and
b) connecting said small device to user's Bluetooth-capable device using Bluetooth wireless technology, and
c) limiting said animal's range of movement in response to changes in animal's physical distance from said user's Bluetooth-capable device
